(19) United States
(12) Patent Application Publication
(10) Pub. No.: US 2025/0116382 A1
(43) Pub. Date: Apr. 10, 2025

(54) GLARE FREE LED RETROFIT LAMP, AUTOMOTIVE LIGHTING SYSTEM, AND METHOD OF ASSEMBLY

(71) Applicant: LUMILEDS LLC, San Jose, CA (US)

(72) Inventors: Lukas Kuepper, Aachen (DE); Dirk Niederste-Werbeck, Aachen (DE)

(73) Assignee: LUMILEDS LLC, San Jose, CA (US)

(21) Appl. No.: 18/377,637

(22) Filed: Oct. 6, 2023

(51) Int. Cl. F21S 41/19; F21S 41/148; F21S 45/48

(52) U.S. Cl. CPC F21S 41/192; F21S 41/148; F21S 45/48

(57) ABSTRACT

A glare free LED retrofit lamp, automotive lighting system and method of assembly are described herein. The glare free LED retrofit lamp includes a referencing ring and a lamp body at least partially in an opening in the referencing ring. A first LED is disposed on a first surface of the lamp body, and a second LED is disposed on a second surface of the lamp body opposite the first surface. The first LED is configured to emit light having a higher color temperature when powered on than light emitted by the second LED when powered on.

### BACKGROUND

Light-emitting diode (LED) retrofit (LRF) lamps may be used as replacement lamps for halogen lamps in automotive systems, such as automotive headlamps. Instead of the filament in a halogen lamp, an LED (or multiple LEDs) may be used in LRF lamps to emit light into the headlight optics. Conventional LRF lamps use LEDs with same color temperature to illuminate the roadway.

### SUMMARY

A glare free LED retrofit lamp, automotive lighting system and method of assembly are described herein. The glare free LED retrofit lamp includes a referencing ring and a lamp body at least partially in an opening in the referencing ring. A first LED is disposed on a first surface of the lamp body, and a second LED is disposed on a second surface of the lamp body opposite the first surface. The first LED is configured to emit light having a higher color temperature when powered on than light emitted by the second LED when powered on.

### BRIEF DESCRIPTION OF THE DRAWINGS

A more detailed understanding can be had from the following description, given by way of example in conjunction with the accompanying drawings wherein:

FIG. 1 is a diagram of an example halogen light source for an automotive headlamp;

FIG. 2 is a diagram showing the light intensity distribution of an example light output of the halogen light source of FIG. 1 centered in a reflector headlamp;

FIG. 3 is a diagram of an example LRF light source for an automotive headlamp;

FIG. 4A is a diagram showing the light intensity distribution of an example light output of the LRF light source of FIG. 3 centered in a reflector headlamp;

FIG. 4B is a diagram showing the light intensity of the LRF light source of FIG. 3 in a simpler representation;

FIG. 5 is a diagram of a first side of an example LRF lamp;

FIG. 6 is a diagram of a second side of an example LRF lamp;

FIG. 7 is a diagram of the light distribution showing how light emitted from the LRF lamp shown in FIGS. 5 and 6 may appear on a white wall when installed in a vehicle headlamp;

FIG. 8 is a diagram of an example vehicle headlamp system; and

FIG. 9 is a flow diagram of an example method of assembling an automotive lighting system.

### DETAILED DESCRIPTION

Examples of different light illumination systems and/or light emitting diode (“LED”) implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

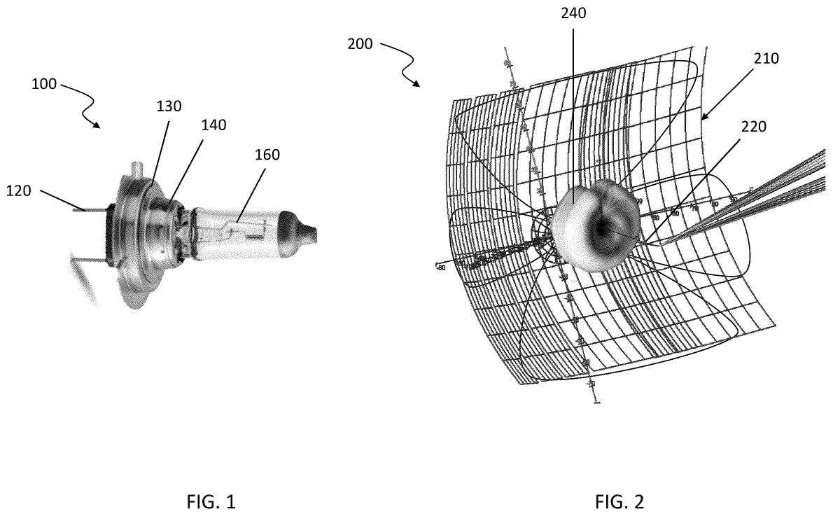

FIG. 1 is a diagram of an example halogen light source 100 for an automotive headlamp. In the example illustrated in FIG. 1, the halogen light source 100 includes a filament 160 in a glass enclosure, which is mechanically coupled to a ring 130 via a base portion 140. The filament 160 may be electrically coupled to a plug 120 via electrical connectors (not shown) routed through the base portion 140 and the ring 130. The plug 120 extends from the ring 130 such that the halogen light source 100 can be plugged into a headlamp (not shown) and receive power from an external power source (e.g., located in another location in the automobile) to power the halogen light source 100 on or off.

FIG. 2 is a diagram 200 showing the light intensity distribution of an example light output of the halogen light source of FIG. 1 centered in a reflector headlamp 210. As can be seen from FIG. 2, the filament 160 of the halogen light source 100 emits light primarily perpendicular to the filament axis 220. The light intensity 240 is, therefore, substantially homogeneous surrounding filament axis 200, and essentially all reflector elements of the reflector 210 receive similar light intensity. In the example illustrated in FIG. 2, there is a dip in light intensity along the filament axis 220 due to the back leading wire of the tungsten filament 160.

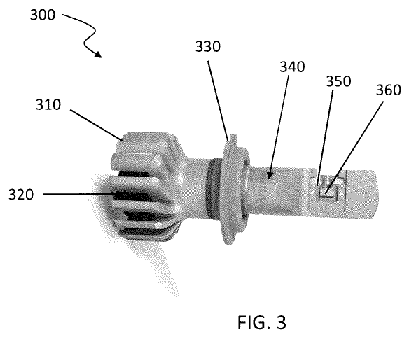

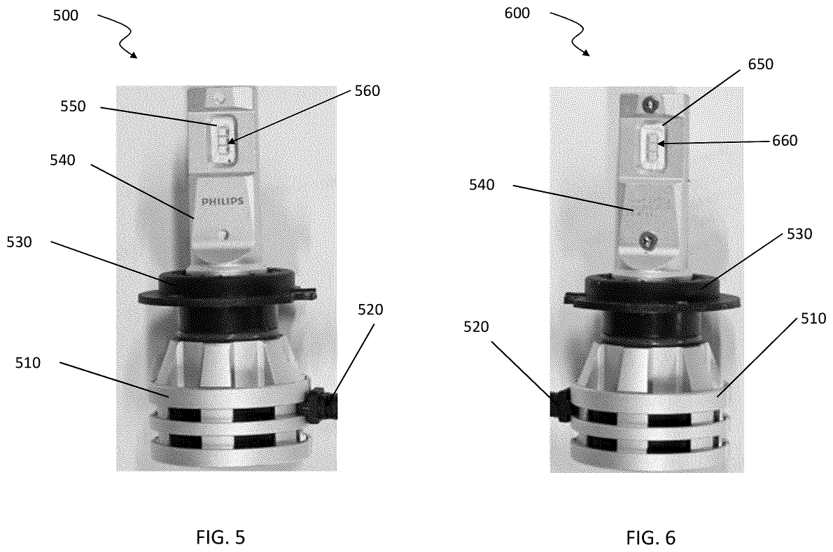

FIG. 3 is a diagram of an example LRF light source 300 for an automotive headlamp. In the example illustrated in FIG. 3, the LRF light source 300 includes a lamp body 340 inserted in a referencing ring 330. The lamp body 340 includes a lighting portion that includes an LED 360 on a heat sink 350, and a rear section 310, which may include heat dissipation elements, such as a heat sink, fins and/or a fan, as well a plug 320 (not visible in FIG. 3). The LED 360 may be a single LED, multiple LEDs or a chip that includes multiple LEDs, for example. While not visible in FIG. 3, another LED 360 may be disposed in the same location on the opposite side of the lamp body 340 (i.e., directly behind the LED 360 that is visible in FIG. 3). This is described in more detail below with respect to FIGS. 5 and 6. The LED 360 is electrically coupled to the plug 320 on the rear section 320 and mechanically coupled to the lamp body 340 such that the LRF light source 300 can be plugged into a headlamp (not shown) and receive power from an external power source (e.g., located in another location in the automobile) to power the LRF light source 300 on or off.

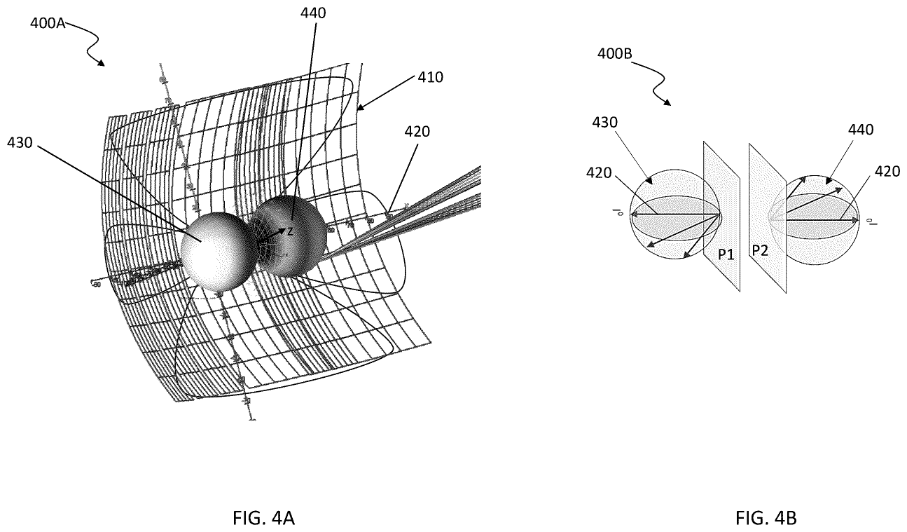

FIG. 4A is a diagram 400A showing the light intensity distribution of an example light output of the LRF light source 300 of FIG. 3 centered in a reflector headlamp 410. As two LEDs 360 are placed back to back in the LRF light source 300, as shown in FIG. 4A, the LRF light source 300 emits light primarily on the horizontal axis 420 of the reflector headlamp 410. As can be seen, rather than one homogenous light intensity surrounding the filament, as shown in FIG. 2 for the halogen light source 100, there are two bulb-shaped areas 430 and 440 of light directed horizontally on either side of the location where the lamp filament 160 would be in the halogen light source 100 of FIG. 1 (e.g., the central axis z labeled in FIG. 4A).

FIG. 4B is a diagram 400B showing the light intensity of the LRF light source 300 of FIG. 3 in a simpler representation. P1 and P2 represent the plane of the heat sink 350 on which the LED 360 is disposed, and the horizontal axis 420 of the reflector headlamp 410 is perpendicular to the planes P1 and P2, as can be seen in FIG. 4B.

While FIGS. 2 and 4A show a reflector headlamp, automotive headlamps may use reflector optics or projector optics. In the case of reflector optics, as illustrated in FIGS. 2 and 4A, the light emitted into the left side of the reflector may illuminate the right side of the road while light emitted into the right side of the reflector may illuminate the left side of the road. The opposite is true for projector optics. In the case of projector optics, light emitted into the left side of the projector may illuminate the left side of the road and light emitted into the right side of the projector may illuminate the right side of the road.

As mentioned above, conventional halogen headlamps, equipped with LRF alike, emit light with a homogeneous color temperature (e.g., light having color temperatures of approximately 2000K to approximately 7000K). Many people, especially when approaching headlights equipped with LED lamps having very high color temperature, complain about strong discomfort glare due to these high color temperatures. Often the same people also complain about poor visibility of the road if the color temperature of their own vehicle is very low like is the case with headlamps equipped with halogen lamps. The driver him or herself may benefit from higher color temperatures because it may provide improved visibility as well as less discomfort glare by lower color temperatures towards oncoming drivers. Taking advantage of the primarily horizontal emission of the LEDs in LED retrofit lamps due to LEDs placed essentially back to back in the lamp, rather than a homogeneous emission from a filament, embodiments described herein provide for an LRF headlamp that may emit light having two different color temperatures such that light having a lower color temperature range may be primarily emitted in the direction of on-coming traffic while light having a higher color temperature range may be primarily emitted in the direction that illuminates portions of the roadway the driver needs to most clearly see.

FIG. 5 is a diagram of a first side 500 of an example LRF lamp. In the example illustrated in FIG. 5, the LRF lamp includes a first side of a base portion 510, which is coupled to a plug 520. The base portion 510 may house electronics and/or drivers that may be required by the LRF lamp as well as include heat dissipating functionality, such as vents, fins or fans. The LRF lamp may also include a first side of a lamp body 540 mechanically coupled to the base portion 510 and inserted through (or otherwise mechanically coupled to) a referencing ring 530. While shown as two separate pieces in FIG. 5, the referencing ring could be a single piece with the lamp body 540 in some embodiments. An LED 560 may be provided on a heat sink or other substrate 550, which may be exposed through an opening in the lamp body 540. While shown sandwiched in the middle of the lamp body 540 (e.g., between two lamp body pieces that are mechanically coupled together), in some embodiments, the heat sink 550 and LEDs 560 may be exposed from an opening on one side of the lamp body 540 (e.g., as shown in FIG. 3) or in other arrangements known in the art. In the example illustrated in FIG. 5, the LED 560 is a chip that includes three (3) LEDs. One of ordinary skill in the art will understand, however, that less than three (3) LEDs may be included or that the LED 560 can be a single LED. Alternatively, the LED 560 could be a larger array of more than three (3) LEDs in some embodiments without deviating from the scope of the embodiments described herein.

The LED 560 may be or include conventional LEDs for automotive headlighting, being configured to emit light having a color temperature in the range of approximately 5500K to approximately 6500K, in some embodiments, or approximately 6000K and above, in some embodiments (e.g., “cool white” or “blue” LEDs). As the LED 560 may include LEDs configured to emit light approximately 6000K or higher in color temperature, such LEDs may be configured to emit light above the color temperature of light emitted by conventional headlamps, which may enable the driver to see the roadway even better than before.

FIG. 6 is a diagram of a second side 600 of an example LRF lamp. The second side 600 of the LRF lamp is opposite the first side 500 of the example LRF lamp shown in FIG. 5.

In the example illustrated in FIG. 6, the LRF lamp includes a second side of the base portion 510, which is coupled to the plug 520. The LRF lamp shown in FIG. 6 may also include a second side of the lamp body 540 mechanically coupled to the base portion 510 and inserted through (or otherwise mechanically coupled to) the referencing ring 530. An LED 660 may be provided on a heat sink or other substrate 650, which may be exposed through an opening in the lamp body 540. While shown sandwiched in the middle of the lamp body 540 (e.g., between two lamp body pieces that are mechanically coupled together), similar to the first side of the LRF lamp shown in FIG. 5, in some embodiments, the heat sink 650 and LED 660 may be exposed from an opening on one side of the lamp body 540 or in other arrangements known in the art. In the example illustrated in FIG. 6, the LED 660 is a chip that includes three (3) LEDs. One of ordinary skill in the art will understand, however, that less than three (3) LEDs may be included or that the LED 660 can be a single LED. Alternatively, the LED 660 could be a larger array of more than three (3) LEDs in some embodiments without deviating from the scope of the embodiments described herein.

The LED 660 is or includes LEDs configured to emit light having a color temperature lower than the color temperature of the LED 560 on the first side of the LRF lamp. Such LED may be configured to emit light having a color temperature, for example, of approximately 5000K or less. Such LEDs may appear as soft white, yellow or amber light to oncoming traffic. In this way, the light that illuminates the portions of the roadway the driver needs to see may be illuminated, either as conventionally lit or even brighter, while the portions of the light emitted by the headlights that may be directed toward oncoming traffic may appear less disruptive to oncoming traffic, reducing or eliminating the amount of “glare” they experience.

To make this possible, referring back to FIG. 4A, for example, for a reflector headlamp, when the LRF lamp of FIGS. 5 and 6 is assembled in the headlamp, it may be oriented such that the first side shown in FIG. 5 faces toward the left side of the vehicle and the second side shown in FIG. 6 faces toward the right side of the vehicle such that the higher color temperature light is directed toward the right side or the road and the lower color temperature light is directed toward the left side of the road. The opposite may be true for a projector type headlamp. This is also the preferred orientation for vehicles that drive on the right side of the road. For vehicles that drive on the left side of the road, the orientations can be reversed. As both sides of the LRF lamp are identical apart from the color of the light emission from the LEDs, the lamp can be placed in either direction depending on the conventions of the country in which the vehicle will be operated and the type of headlamp in which the lamp is being used (e.g. reflector type or projector type).

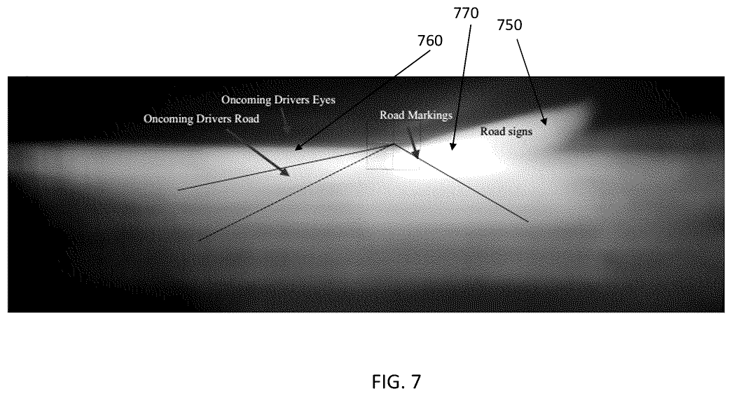

FIG. 7 is a diagram showing how light emitted from the LRF lamp shown in FIGS. 5 and 6 may appear on the roadway when installed in a vehicle headlamp. A region of light 750 may have the highest color temperature, illuminating road signs with a blue or cooler white light that will make them more visible to the driver. A region of light 770 may have a lower color temperature than light illuminating the region 750, such as cool white light, illuminating road markings with a light bright enough for the driver to see them. As the light illuminating the roadway gets closer to oncoming traffic, the color temperature of the light illuminating the roadway becomes warmer. For example, in a region of light 760 near oncoming drivers eyes and the roadway in front of oncoming drivers, the color temperature of light may be the lowest color temperature (e.g., 5000K or less, appearing warm white, yellow or amber in areas closest to the oncoming driver's eyes).

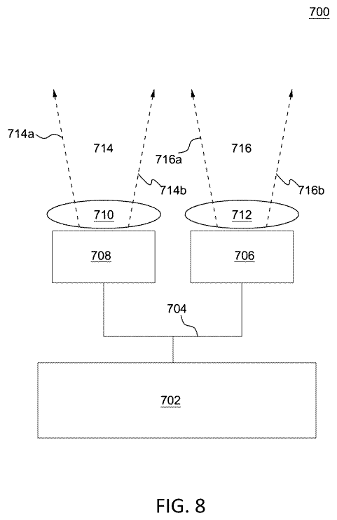

FIG. 8 is a diagram of an example vehicle headlamp system 700. The example vehicle headlamp system 700 illustrated in FIG. 7 includes an application platform 702, two LED lighting systems 706 and 708, and secondary optics 710 and 712.

The LED lighting system 708 may emit light beams 714 (shown between arrows 714a and 714b in FIG. 7). The LED lighting system 706 may emit light beams 716 (shown between arrows 716a and 716b in FIG. 7). In the embodiment shown in FIG. 7, a secondary optic 710 is adjacent the LED lighting system 708, and the light emitted from the LED lighting system 708 passes through the secondary optic 710. Similarly, a secondary optic 712 is adjacent the LED lighting system 706, and the light emitted from the LED lighting system 706 passes through the secondary optic 712. In alternative embodiments, no secondary optics 810/812 are provided in the vehicle headlamp system. The LED lighting systems 706 and 708 may include the LRF lamps described herein installed in a reflector or projection headlamp.

Where included, the secondary optics 710/712 may be or include one or more light guides. The one or more light guides may be edge lit or may have an interior opening that defines an interior edge of the light guide. LED lighting systems 708 and 706 may be inserted in the interior openings of the one or more light guides such that they inject light into the interior edge (interior opening light guide) or exterior edge (edge lit light guide) of the one or more light guides. In embodiments, the one or more light guides may shape the light emitted by the LED lighting systems 708 and 706 in a desired manner, such as, for example, with a gradient, a chamfered distribution, a narrow distribution, a wide distribution, or an angular distribution.

The application platform 702 may provide power and/or data to the LED lighting systems 706 and/or 708 via lines 704. One or more sensors (which may be the sensors in the vehicle headlamp system 700 or other additional sensors) may be internal or external to the housing of the application platform 702. Alternatively, or in addition, each LED lighting system 708 and 706 may include its own sensor module, connectivity and control module, power module, and/or LED array.

In embodiments, the vehicle headlamp system 700 may represent an automobile with steerable light beams where LEDs may be selectively activated to provide steerable light. For example, an array of LEDs or emitters may be used to define or project a shape or pattern or illuminate only selected sections of a roadway. In an example embodiment, infrared cameras or detector pixels within LED lighting systems 706 and 708 may be sensors that identify portions of a scene (e.g., roadway or pedestrian crossing) that require illumination.

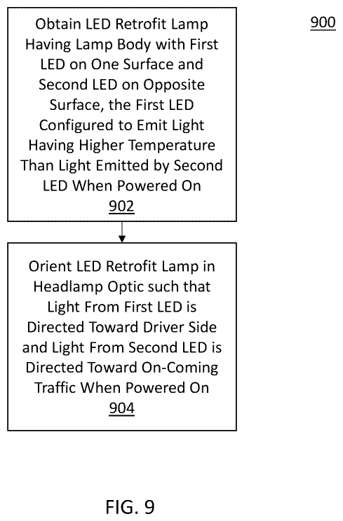

FIG. 9 is a flow diagram 900 of an example method of assembling an automotive lighting system. An LED retrofit lamp is obtained (902). The LED retrofit lamp may be an LED retrofit lamp as in any of the examples described above. The LED retrofit lamp may be oriented in a headlamp optic (904) such that light from the first LED when powered on is directed by the headlamp optic toward one of a left side or a right side relative to a central axis of the headlamp optic and the light emitted from the second LED when powered on is directed by the headlamp optic toward an opposite one of the left side or the right side relative to the central axis of the headlamp optic from the side toward which the light emitted from the first LED is directed. The side to which light emitted from the first LED when powered on is directed may be the driver's side and the side to which light emitted from the second LED when powered on is directed may be the side of on-coming traffic.

As would be apparent to one skilled in the relevant art, based on the description herein, embodiments of the present invention can be designed in software using a hardware description language (HDL) such as, for example, Verilog or VHDL. The HDL-design can model the behavior of an electronic system, where the design can be synthesized and ultimately fabricated into a hardware device. In addition, the HDL-design can be stored in a computer product and loaded into a computer system prior to hardware manufacture.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

1. A light-emitting diode (LED) retrofit lamp comprising:
a referencing ring;
a lamp body at least partially in an opening in the referencing ring;
a first LED on a first surface of the lamp body; and
a second LED on a second surface of the lamp body opposite the first surface,
the first LED configured to emit light having a first color temperature higher than a second color temperature of light emitted by the second LED when powered on at the same time to produce a combined light pattern whereby light emitted by the first LED illuminates a first portion of a roadway and light emitted by the second LED illuminates a second portion of the roadway to clearly illuminate objects a driver needs to see while reducing glare on oncoming traffic.

2. The LED retrofit lamp of claim 1, wherein the first color temperature is approximately 6000K or higher and the second color temperature is approximately 5000K or lower.

3. The LED retrofit lamp of claim 1, wherein the first color temperature is approximately 5500K to approximately 6500K.

4. The LED retrofit lamp of claim 1, wherein the first LED and the second LED are each provided on a heat sink and exposed through an opening in the first surface and the second surface, respectively, of the lamp body.

5. The LED retrofit lamp of claim 1, wherein the first LED is one of a single LED, a plurality of LEDs or a chip comprising a plurality of LEDs.

6. The LED retrofit lamp of claim 1, wherein the first LED is configured to emit cool white or blue light when powered on, and the second LED is configured to emit warm white, yellow or amber light when powered on.

7. An automotive lighting system comprising:
a headlamp optic; and
a light-emitting diode (LED) retrofit lamp comprising:
a lamp body,
a first LED on a first surface of the lamp body, and
a second LED on a second surface of the lamp body opposite the first surface,
the first LED configured to emit light having a first color temperature higher than a second color temperature of light emitted by the second LED when powered on at the same time to produce a combined light pattern,
the LED retrofit lamp oriented in the headlamp optic such that the light emitted from the first LED when powered on is directed by the headlamp optic toward one of a left side or a right side relative to a central axis of the headlamp optic and the light emitted from the second LED when powered on is directed by the headlamp optic toward an opposite one of the left side or the right side relative to the central axis of the headlamp optic from the side toward which the light emitted from the first LED is directed.

8. The system of claim 7, wherein the first color temperature is approximately 6000K or higher and the second color temperature is approximately 5000K or lower.

9. The system of claim 7, wherein the first color temperature is approximately 5500K to approximately 6500K.

10. The system of claim 7, wherein one of the left side or the right side is a driver side of a vehicle and the other one of the left side or the right side is the direction of on-coming traffic.

11. The system of claim 8, wherein the LED retrofit lamp is oriented in the headlamp optic such that the light emitted from the first LED is directed toward the driver side of the vehicle when powered on and the light emitted from the second LED is directed toward the on-coming traffic when powered on.

12. The system of claim 7, wherein the headlamp optic is one of a reflector optic or a projector optic.

13. The system of claim 7, wherein the LED retrofit lamp further comprises a referencing ring, and the lamp body is disposed at least partially in an opening in the referencing ring, the referencing ring mechanically coupling the LED retrofit lamp to the headlamp optic.

14. The system of claim 7, wherein the first LED is one of a single LED, a plurality of LEDs or a chip comprising a plurality of LEDs.

15. The LED retrofit lamp of claim 7, wherein the first LED is configured to emit cool white or blue light when powered on, and the second LED is configured to emit warm white, yellow or amber light when powered on.

17. A method of assembling an automotive lighting system, the method comprising:
obtaining a light-emitting diode (LED) retrofit lamp comprising:
a lamp body,
a first LED on a first surface of the lamp body, and
a second LED on a second surface of the lamp body opposite the first surface,
the first LED configured to emit light having a first color temperature higher than a second color temperature of light emitted by the second LED when powered on at the same time as the second LED to produce a combined light pattern; and
orienting the LED retrofit lamp in a headlamp optic such that the light emitted from the first LED when powered on is directed by the headlamp optic toward one of a left side or a right side relative to a central axis of the headlamp optic and the light emitted from the second LED when powered on is directed by the headlamp optic toward an opposite one of the left side or the right side relative to the central axis of the headlamp optic from the side toward which the light emitted from the first LED is directed.

18. The method of claim 17, wherein one of the left side or the right side is a driver side of a vehicle and the other one of the left side or the right side is the direction of on-coming traffic.

19. The method of claim 17, wherein the orienting the LED retrofit lamp comprises orienting the LED retrofit lamp such that the light emitted from the first LED is directed toward the driver side of the vehicle when powered on and the light emitted from the second LED is directed toward the on-coming traffic when powered on.

20. The method of claim 17, wherein the first LED is configured to emit cool white or blue light when powered on, and the second LED is configured to emit warm white, yellow or amber light when powered on.
